(19) United States
(12) Patent Application Publication
(10) Pub. No.: US 2005/0025883 A1
(43) Pub. Date: Feb. 3, 2005

(54) Brake component having a coating material applied thereto, method for producing such a brake component and brake assembly including such a brake component

(76) Inventors: Yongbin Yuan, Novi, MI (US); Steven M. Johnson, Dexter, MI (US); Richard M. Coco, Clinton Township, MI (US)

Correspondence Address: MACMILLAN, SOBANSKI & TODD, LLC, ONE MARITIME PLAZA - FOURTH FLOOR, 720 WATER STREET, TOLEDO, OH, 43604, US

(21) Appl. No.: 10/812,350

(22) Filed: Mar. 29, 2004

Related U.S. Application Data
(63) Continuation of application No. PCT/US02/33434, filed on Oct. 21, 2001.

(51) Int. Cl. B05D 1/12

(52) U.S. Cl. 427/180; 427/421.1; 427/428.01; 427/429; 427/430.1; 188/251 A

(57) ABSTRACT

This invention relates to a brake component having a coating material applied thereto adapted for use in a vehicle brake assembly, method for producing such a brake component, and a vehicle brake assembly including such a brake component. The brake component is selected from the group consisting of brake shoe and a brake rotor. The brake shoe includes a friction lining having an outer surface having surface irregularities and the brake rotor including an inner cylindrical braking surface having surface irregularities. The surfaces of the brake components are disposed adjacent one another and adapted to frictionally engage one another when the brake assembly is actuated. The brake component surface having the surface irregularities prevents complete contact between the adjacent surfaces of the brake components prior to any burnishing or other contact or wear of components. According to the present invention, a green static coefficient of friction between the adjacent surfaces of the brake components is increased by applying a coating material to at least a portion of the surface of one of the brake components whereby the coating material is operative to at least partially fills in at least some of the surface irregularities so as to increase a contact area between the surfaces of the brake components thereby increasing the green static coefficient of friction between the surfaces of the brake components when the brake assembly is actuated.

### CROSS-REFERENCE TO RELATED APPLICATIONS

This application is a continuation of PCT/US02/33434, filed Oct. 21, 2002, which claims the benefit of U.S. Provisional Application Ser. No. 60/338,902, filed Oct. 22, 2001.

### BACKGROUND OF THE INVENTION

This invention relates in general to vehicle brake assemblies and in particular to a brake component having a coating material applied thereto for use in such a vehicle brake assembly, method for producing such a brake component, and a vehicle brake assembly including such a brake component.

Most vehicles are equipped with a brake system for slowing or stopping movement of the vehicle in a controlled manner. A typical brake system for an automobile or light truck includes a disc brake assembly for each of the front wheels and either a drum brake assembly or a disc brake assembly for each of the rear wheels. In some instances, the disc brake assembly can be a “drum-in-hat” type of disc brake assembly. The brake assemblies are actuated by hydraulic or pneumatic pressure generated when an operator of the vehicle depresses a brake pedal. The structures of these drum brake assemblies and disc brake assemblies, as well as the actuators therefor, are well known in the art.

A typical drum-in-hat type of disc brake assembly includes a hydraulically or pneumatically actuated disc service brake and a mechanically actuated drum-in-hat parking and emergency brake. The disc service brake includes a rotor which is secured to the wheel of the vehicle for rotation therewith. The rotor includes a pair of opposed friction plates which are selectively engaged by portions of a caliper assembly. The interior of the rotor defines a cylindrical braking surface.

A caliper assembly is slidably supported by pins secured to a mounting flange. The mounting flange is secured to a non-rotatable component of the vehicle, such as the steering knuckle or the axle flange. The caliper assembly includes a pair of brake shoes which are disposed on opposite sides of the rotor. The brake shoes are operatively connected to one or more hydraulically actuated pistons for movement between a non-braking position, wherein they are spaced apart from the opposed friction plates of the rotor, and a braking position, wherein they are moved into frictional engagement with the opposed friction plates of the rotor. When the operator of the vehicle depresses the brake pedal, the piston urges the brake shoes from the non-braking position to the braking position so as to frictionally engage the friction plates of the rotor and thereby slow or stop the rotation of the associated wheel of the vehicle.

The drum-in-hat parking and emergency brake includes a pair of opposed arcuate brake shoes which are supported on a backing plate for selective movement relative thereto. The backing plate is secured to the mounting flange, or alternatively, can be formed integral therewith. Each of the brake shoes has a friction lining or pad secured thereto. The brake shoes extend within the cylindrical braking surface of the rotor. To effect parking and emergency braking action, the operator of the vehicle manually pulls an actuating lever. The lever is connected to an acutation cable having a park brake cable end which, when pulled, actuates a mechanical actuating mechanism. The actuating mechanism is located adjacent one of the ends of the brake shoes and is operative to move the brake shoes outwardly apart from one another such that the friction linings frictionally engage the cylindrical braking surface of the rotor. Such frictional engagement causes slowing or stopping of the rotational movement of the rotor and, therefore, the wheel of the vehicle in a controlled manner.

### SUMMARY OF THE INVENTION

This invention relates to a brake component having a coating material applied thereto for use in a vehicle brake assembly, method for producing such a brake component, and a vehicle brake assembly including such a brake component. The brake component is selected from the group consisting of brake shoe and a brake rotor. The brake shoe includes a friction lining having an outer surface having surface irregularities and the brake rotor including an inner cylindrical braking surface having surface irregularities. The surfaces of the brake components are disposed adjacent one another and adapted to frictionally engage one another when the brake assembly is actuated. The brake component surface having the surface irregularities prevents complete contact between the adjacent surfaces of the brake components prior to any burnishing or other contact or wear of the components. According to the present invention, a green static coefficient of friction between the adjacent surfaces of the brake components is increased by applying a coating material to at least a portion of the surface of one of the brake components whereby the coating material is operative to at least partially fills in at least some of the surface irregularities so as to increase the contact area between the surfaces of the brake components thereby increasing the green static coefficient of friction between the surfaces of the brake components when the brake assembly is actuated. The method for producing the brake component of the present invention comprises the steps of: (a) providing a brake component selected from the group consisting of brake shoe and a brake rotor, the brake shoe including a friction lining having an outer surface having surface irregularities and the brake rotor including an inner cylindrical braking surface having surface irregularities; (b) applying a liquid binder material to at least a portion of one of the outer surface of the friction lining of the brake shoe and the inner cylindrical braking surface of the brake rotor; and (c) applying a coating material to at least a portion of one of the outer surface of the friction lining of the brake shoe and the inner cylindrical braking surface of the brake rotor to at least partially fill in the surface irregularities thereof and thereby increase a contact area between the outer surface of the friction lining and the inner cylindrical braking surface of the brake rotor.

Other advantages of this invention will become apparent to those skilled in the art from the following detailed description of the preferred embodiments, when read in light of the accompanying drawings.

### BRIEF DESCRIPTION OF THE DRAWINGS

FIG. 1 is an outboard side elevational view of a vehicle disc brake assembly constructed in accordance with this invention.

FIG. 2 is an inboard side elevational view of the vehicle disc brake assembly with the bolts removed.

FIG. 3 is a sectional elevational view of the vehicle disc brake assembly.

FIGS. 4 and 4A illustrate selected portions of the vehicle disc brake assembly according to a first embodiment of this invention.

FIGS. 5 and 5A illustrate selected portions of the vehicle disc brake assembly according to a second embodiment of this invention.

FIGS. 6 and 6A illustrate selected portions of the vehicle disc brake assembly according to a third embodiment of this invention.

FIG. 7 illustrates a first sequence of steps for producing the brake component part for use in the vehicle disc brake assembly of this invention.

FIG. 8 illustrates a second alternate sequence of steps for producing the brake component part for use in the vehicle disc brake assembly of this invention.

### DETAILED DESCRIPTION OF THE PREFERRED EMBODIMENTS

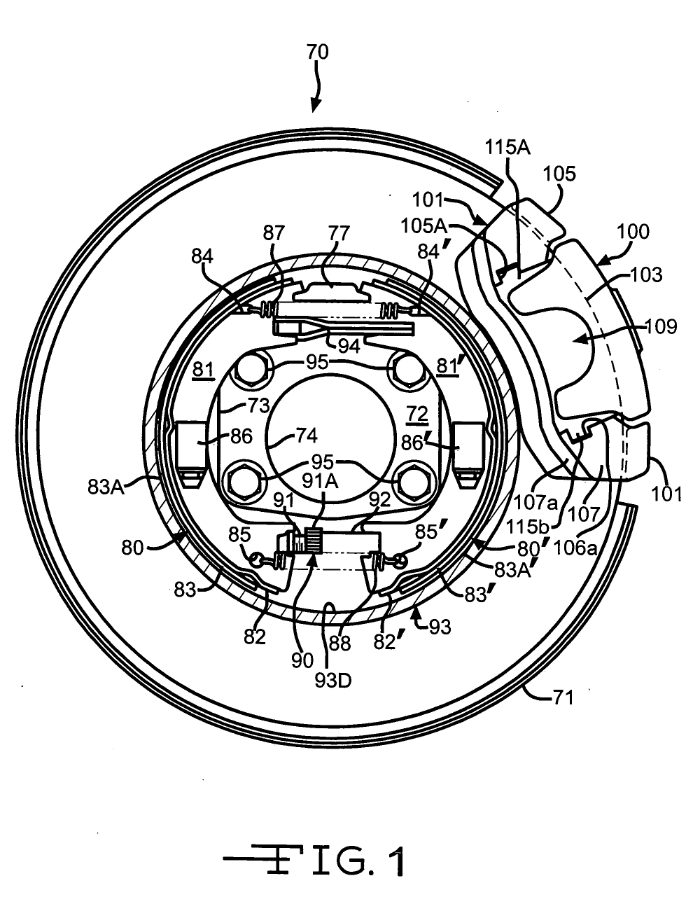

Referring now to FIGS. 1-3, there is illustrated a “drum-in-hat” disc brake assembly, indicated generally at 70, in accordance with the present invention. The disc brake assembly 70 includes a hydraulically actuated disc service brake and a drum-in-hat parking and emergency brake. The type of disc brake assembly 70 can be similar to that illustrated in U.S. Pat. Nos. 5,180,037, 5,322,145, and 4,854,423 to Evans, the disclosures of these patents herein incorporated by reference. Although the present invention will be illustrated and described in conjunction with the particular drum-in-hat disc brake assembly 70 disclosed herein, it will be appreciated that this invention can be used in conjunction with other types of drum-in-hat disc brake assemblies and/or other kinds of drum brake assemblies if so desired.

As shown in the drawings, the illustrated drum-in-hat disc brake assembly 70 includes a stamped metal backing plate 71, which is generally flat and circular in shape, and a one-piece casting 72, which is generally circular in shape. The backing plate 71 and the casting 72 are secured to a fixed, non-rotatable component of the vehicle, such as a steering knuckle (not shown) for enclosing a rotatable axle. To accomplish this, a relatively large opening 73 is formed through the central portion of the backing plate 71, and a smaller opening 74 is formed through the central portion of the casting 72. The openings 73 and 74 are provided to permit an outer end of the rotatable axle to extend therethrough to the driven vehicle wheel (not shown).

The casting 72 includes a plurality of holes 72A formed therethrough which are adapted to allow bolts 95 to be received therein. The bolts 95 have respective threaded ends (not shown), which are received in threaded openings (not shown) formed in the vehicle component to secure the casting 72 thereto. A plurality of relatively smaller holes (not shown) are also formed through the backing plate 71. These smaller holes are provided to allow suitable fasteners, such as for example rivets (not shown) to extend therethrough and secure the backing plate 71 to the casting 72. Alternatively, the backing plate 71 can be secured to the casting 72 by other means. For example, self-tapping screws (not shown) and bolts and nuts (not shown) can be used if so desired. The illustrated backing plate 71 includes an annular groove 75 formed therein, and an outer annular portion 76 which defines a shield.

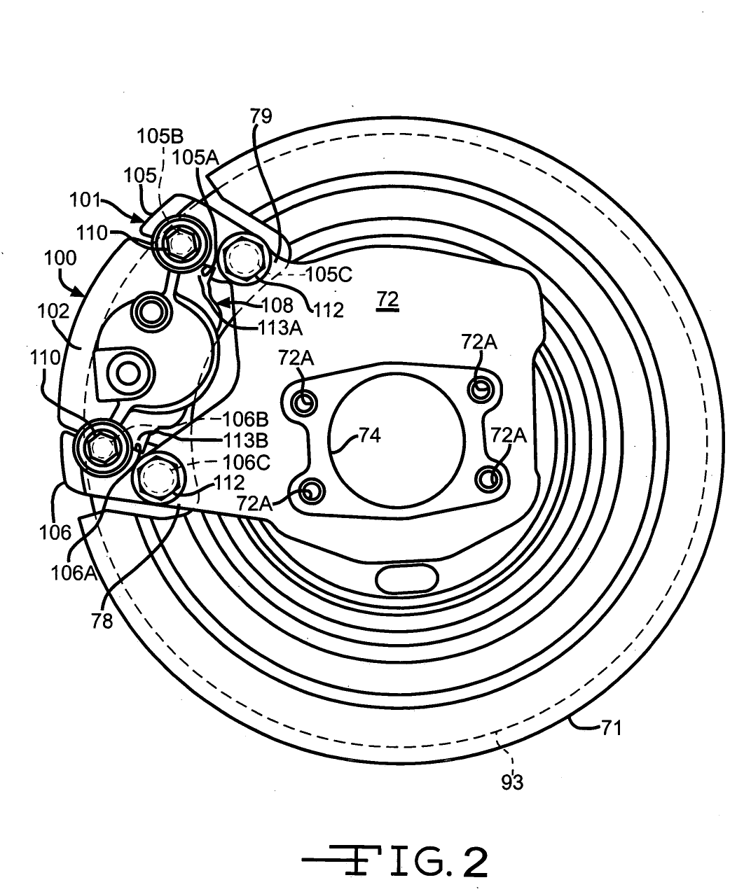

In the illustrated embodiment, the casting 72 includes an integrally cast abutment block 76 provided on an outer surface thereof. The abutment block 76 extends axially through an opening formed in the backing plate 71. Also, a pair of integrally cast ears 78 and 79, shown in FIG. 2, are provided on the casting 72. Alternatively, the structure of the backing plate 71 and/or the casting 72 can be other than illustrated. For example, the backing plate 71 and the casting 72 can be cast integrally as one-piece and/or the ears 78 and 79 can be separate components and secured to the casting 72 by appropriate means.

The drum-in-hat parking and emergency brake of the disc brake assembly 70 includes first and second brake shoes, indicated generally at 80 and 80′. Structurally, the brake shoes 80 and 80′ are essentially mirror images of one another, and like reference numbers are used to indicate similar parts. The brake shoes 80 and 80′ include respective web portions 81 and 81′ which are generally flat and crescent-shaped. Arcuate table portions 82 and 82′ are secured to the opposed outer curved surfaces of the web portions 81 and 81′, such as by welding. A friction lining 83 is secured to the outer arcuate surface of the table portion 82 of the brake shoe 80, while a friction lining 83′ is secured to the outer arcuate surface of the table portion 82′ of the brake shoe 80′. The friction lining 83 includes an outer surface 83A, and the friction lining 83′ includes an outer surface 83A′. Openings 84 and 84′ are provided near the upper ends of the web portions 81 and 81′, respectively, of the brake shoes 80 and 80′. Also, openings 85 and 85′ are provided through the lower ends of the web portions 81 and 81′, respectively, of the brake shoes 80 and 80′, for a purpose to be discussed below.

The first and second brake shoes 80 and 80′ are supported on the backing plate 71 by respective pivot pin and spring-clip assemblies, indicated generally at 86 and 86′, which are conventional in the art. As shown in FIG. 1, the upper ends of the web portions 81 and 81′ of the brake shoes 80 and 80′ extend into abutment with the opposed sides of the abutment block 76.

The drum-in-hat parking and emergency brake includes a first or upper coiled spring 87 and a second or lower coiled spring 88. The upper coiled spring 87 has hooked ends which extend through the openings 84 and 84′ provided near the upper ends of the web portions 81 and 81′, respectively, so as to urge such upper ends thereof into abutment with abutment block 76. The lower coiled spring 88 has hooked ends which extend through the openings 85 and 85′ formed through the lower ends of the web portions 81 and 81′, respectively, so as to urge the lower ends toward one another.

The drum-in-hat parking and emergency brake further includes a manual adjusting mechanism 90. The mechanism 90 is provided to compensate for thinning of the friction linings 83 and 83′ resulting from wear caused by repeated use of the brake assembly 70. The illustrated adjusting mechanism 90 is conventional in the art and includes a pair of mutually threaded struts 91 and 92 having opposed slotted ends. The lower ends of the web portions 81 and 81′ of the brake shoes 80 and 80′, respectively, are received within the slotted ends of the struts 91 and 92. A star wheel portion 91 a is formed integrally on the strut 91 or secured thereto by suitable means. An actuating lever 94 is supported between the upper ends of the web portions 81 and 81′ of the brake shoes 80 and 80′, respectively. The actuating lever 94 is connected by an actuation cable (not shown) which is conventional in the art and which is connected to a hand operated lever or similar manually operable parking and emergency brake mechanism for manually actuating the parking and emergency brake.

The disc brake assembly 70 further includes an annular rotor 93 which is secured to a wheel (not shown) of the vehicle for rotation therewith. The illustrated rotor 93 includes a pair of radially extending opposed braking surfaces 93A and 93B, which are spaced apart from one another in a known manner, and an axially extending annular projection 93C. The interior of the rotor 93 defines a finish machined inner cylindrical “drum” braking surface 93D. When assembled, the brake shoes 80 and 80′ are disposed within the inner cylindrical braking surface 93D. To effect parking and emergency braking action, the actuating lever 94 is pulled, causing the lever 94 to move the brake shoes 80 and 80′ apart from one another and into frictional engagement with the inner cylindrical braking surface 93d of the rotor 93 in a known manner.

The hydraulically actuated service brake of the disc brake assembly 70 includes a generally C-shaped caliper 100 and an anchor plate 101. The caliper 100 includes an inboard leg portion 102 and an outboard leg portion 103 which are interconnected by an intermediate bridge portion 104.

The illustrated anchor plate 101 includes a pair of outwardly extending arms 105 and 106, the outboard ends thereof being interconnected by a single outer tie bar 107. In the illustrated embodiment, the arms 105 and 106 are provided with pairs of notches 105A and 106A, respectively, formed therein to slidably support an inboard brake shoe 108 and an outboard brake shoe 109, respectively. The inboard end of the arm 105 is provided with a pair of threaded apertures 105B and 105C, and the inboard end of the 106 is provided with a pair of threaded apertures 106B and 106C.

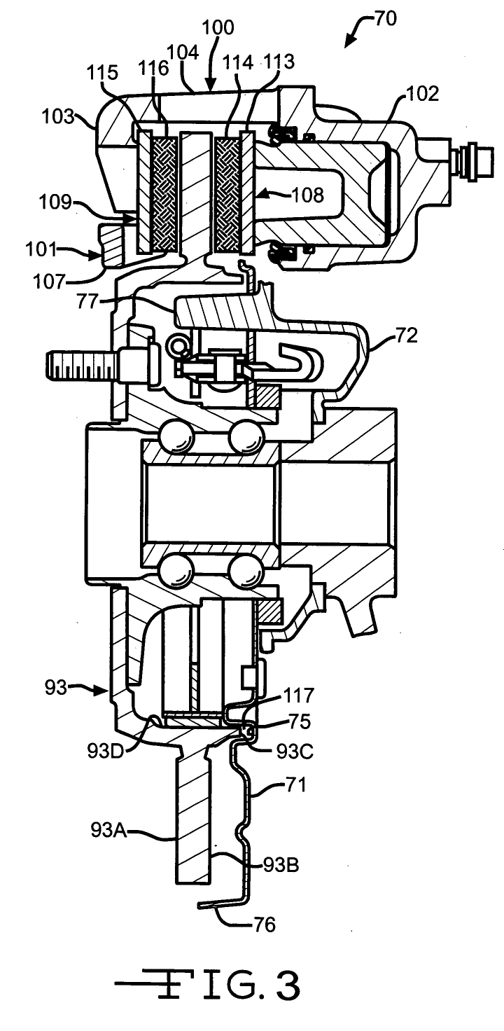

The caliper 100 is slidably supported on a pair of bolts 110 secured to the anchor plate 101. In particular, the bolts 110 extend through apertures (not shown) formed in the inboard leg 102 of the caliper 100. The bolts 110 have respective threaded ends 110a which are received in the threaded apertures 105b and 106b formed in the arms 105 and 106, respectively, of the anchor plate 101. The bolts 110 permit the caliper 100 to slide in both the outboard direction (left when viewing FIG. 3) and the inboard direction (right when viewing FIG. 3). The anchor plate 100 is secured to the casting 72 by a pair of bolts 112. The bolts 112 extend through apertures (not shown) formed in the casting 72, and have respective threaded ends (not shown) which are received in the threaded apertures 105C and 106C of the arms 105 and 106, respectively, of the anchor plate 101.

The illustrated inboard brake shoe 108 includes a backing plate 113 and a friction lining 114. The inboard backing plate 113 includes opposed ends having circumferentially extending tabs 113A and 113B provided thereon, for supporting the inboard brake shoe 108 in the notches 105A and 106A of the arms 105 and 106, respectively, of the anchor plate 101. The outboard brake shoe 109 includes a backing plate 115 and a friction lining 116. The outboard backing plate 115 includes opposed ends having circumferentially extending tabs 115A and 115B provided thereon, for supporting the outboard brake shoe 109 in the notches 105A and 106A of the arms 105 and 106 of the anchor plate 101. Alternatively, the structure of the anchor plate 101 can be other than illustrated if so desired. The structure and operation of the drum-in-hat disc brake assembly 70 thus far described is conventional in the art.

In accordance with the present invention, the outer surface 83A and 83A′ of the friction linings 83 and 83′, respectively, and/or the finish machined inner cylindrical braking surface 93D of the rotor 93 are coated with a preselected material to increase the static coefficient of friction of the associated component part of the brake assembly. A suitable “coating” material can include iron oxide powder (Fe₂O₃); aluminum oxide powder (Al₂O₃); zircon powder; and calcium oxide powder (CₐCO₃). Preferably, the powdered coating materials are a fine powdered mildly abrasive coating material having a particle size of about 5 microns or less. Alternatively, the size of the particles of the coating material can be greater than 5 microns if so desired. Also, other suitable powdered and non-powdered coating materials can be used if so desired.

Preferably, in order to coat the outer surfaces 83A and 83A′ of the respective friction linings 83 and 83′ and/or the inner cylindrical braking surface 93D of the rotor 93, the surfaces are first coated with a liquid binder and then one of the above coating materials are applied. A suitable liquid binder can include a liquid phenolic resin and a silicate binder. Also, the liquid binder can be mixed with water or other non-binder liquids if so desired. Alternatively, the coating material can be mixed with the binder and then applied by any suitable process, such as for example, by spray, dip, blot, brush, ink-pad or roller coating processes. In addition, the coating is preferably applied of a uniform thickness to the selected surface(s) of the brake component and preferably the coating is applied to cover the entire area of such selected surface(s); however, the coating can be applied of a non-uniform thickness to the selected surface(s) and/or the coating can be applied to cover less than the entire area of such selected surface(s) can be coated if so desired.

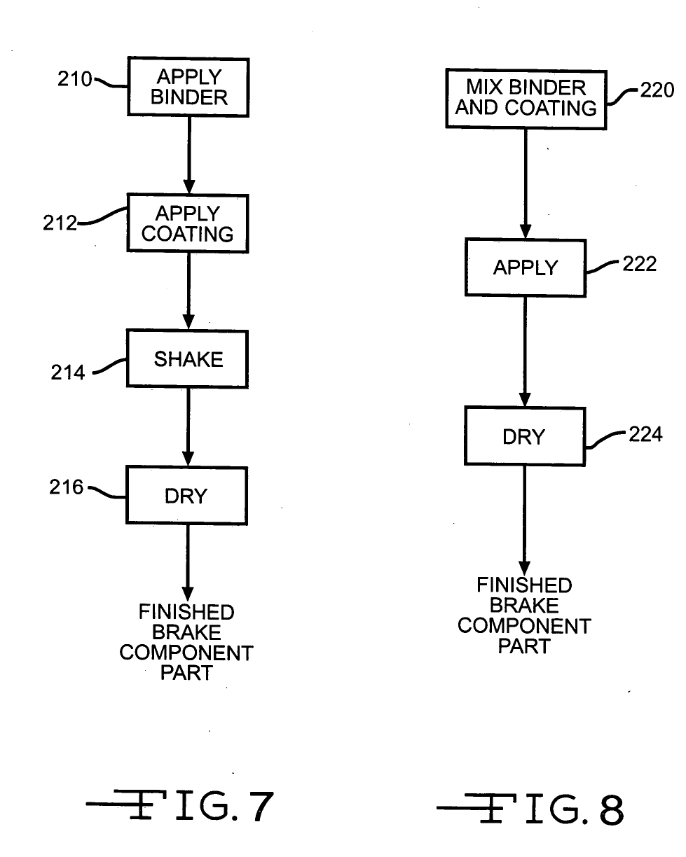

Turning now to FIG. 7, there is illustrated a first sequence of steps for coating the outer surfaces 83A and 83A′ of the respective friction linings 83 and 83′ and/or the inner cylindrical braking surface 93D of the rotor 93. As shown therein, the sequence includes the steps of: step 210—applying a liquid binder to the selected brake component surface; step 212—applying a coating material to the selected brake component surface already having the liquid binder applied thereto; step 214—shaking off any excess coating material; and step 216—allowing the coating material and the binder to dry and harden. Step 216 can be done at ambient temperature or at an elevated temperature if so desired.

Turning now to FIG. 8, there is illustrated a second sequence of steps for coating the outer surfaces 83A and 83A′ of the respective friction linings 83 and 83′ and/or the inner cylindrical braking surface 93D of the rotor 93. As shown therein, the sequence includes the steps of: step 220—mixing the coating material and the liquid binder into a slurry or paste mixture; step 222—applying the mixture to the outer surface of the friction linings 83 and 83′ and/or the inner cylindrical braking surface 93d of the rotor 93; and step 224—allowing the mixture to dry and harden. Step 222 can be accomplished by any suitable coating process, such as for example, by spraying, dipping, blotting, brushing, ink-padding or roller coating processes. Step 224 can be done at ambient temperature or at an elevated temperature if so desired.

In accordance with the present invention, the “green” static coefficient of friction between the associated brake component parts is increased due to the increase of the “true contact area” between the parts so long as the selected coating material has acceptable frictional increasing properties. The term green static coefficient of friction as used herein means the static coefficient of friction between the associated new brake component parts before any burnishing or other contact/wear of the parts has occurred. The coating of the present invention is intended to function as disclosed herein until at least the friction linings are burnished and/or other contact/wear of the parts has occurred.

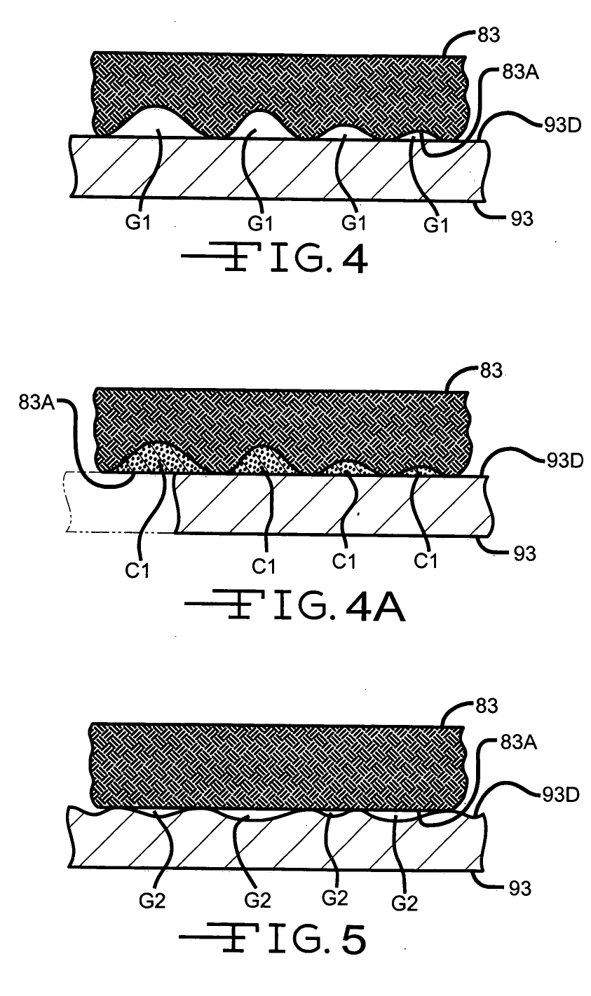

As shown in FIGS. 4-6, at least one of the surfaces of the outer surfaces 83A and 83A′ of the friction linings 83 and 83′, respectively, and/or the inner cylindrical braking surface 93D of the rotor 93 is not “true” but rather has surface irregularities or gaps therein, as will be discussed below. This means that there is not true or complete contact between the adjacent surfaces when the parking brake is applied. By coating the outer surfaces 83A and 83A′ of the respective friction linings 83 and 83′ and/or the inner cylindrical braking surface 93D of the rotor 93 in accordance with the present invention, the true contact area between the surfaces can be increased or built-up thereby increasing the static coefficient of friction between the surfaces of these parts.

In particular, as shown in the embodiment illustrated in FIG. 4, the outer surface 83A of the friction lining 83 has surface irregularities or gaps, indicated generally at G1 therein which prevent true or complete contact between the outer surface 83A and the inner surface 93D when the parking brake is applied. The surface irregularities G1 on the outer surface 83A of the friction lining 83 are typically the result of machining, such as for example, grinding or lathe turning. In accordance with this invention as shown in FIG. 4A, the outer surface 83A of the friction lining 83 is coated according to this invention with a suitable coating material C1 to at least partially fill in and as illustrated, to preferably completely fill in the gaps G1 so that the true contact area between these surfaces is increased.

As shown in the embodiment illustrated in FIG. 5, the inner cylindrical braking surface 93D of the rotor 93 has surface irregularities or gaps, indicated generally at G2 therein which prevent true or complete contact between the outer surface 83A and the inner surface 93D when the parking brake is applied. The surface irregularities G2 on the inner cylindrical braking surface 93D of the rotor 93 are typically the result of machining, such as for example, grinding or lathe turning. In accordance with this invention as shown in FIG. 5A, the inner surface 93D of the rotor 93 is coated according to this invention with a suitable coating material C2 to at least partially fill in and as illustrated, to preferably completely fill in the gaps G2 so that the true contact area between these surfaces is increased.

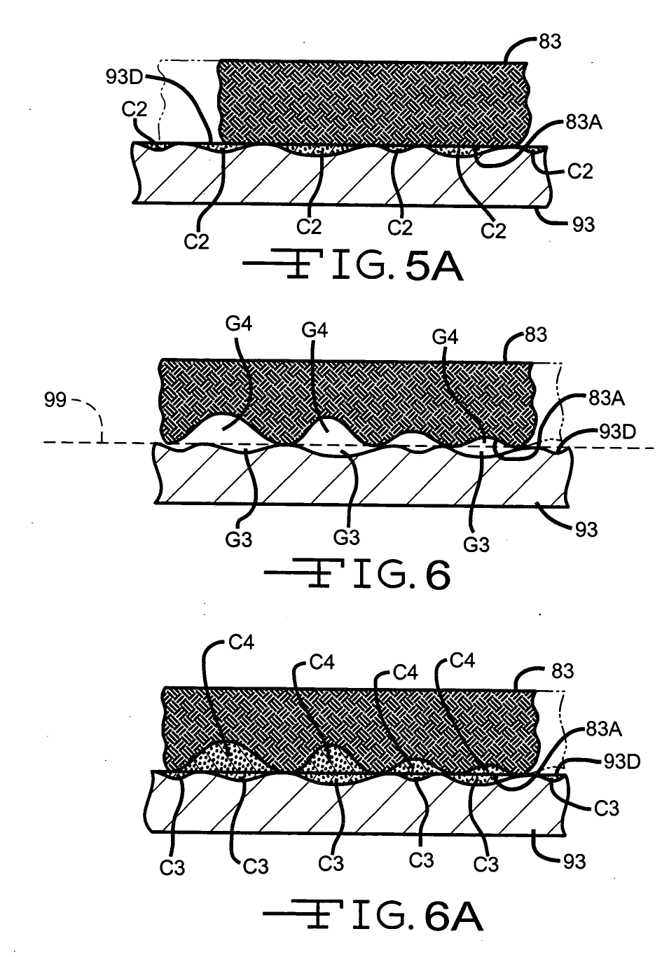

As shown in the embodiment illustrated in FIG. 6, the inner cylindrical braking surface 93D of the rotor 93 has surface irregularities or gaps, indicated generally at G3 therein and also the outer surface 83A of the friction lining 83 has surface irregularities or gaps, indicated generally at G4 therein which prevent true or complete contact between the outer surface 83A and the inner surface 93D when the parking brake is applied. (For clarity purposes, a dotted line 99 is included in FIG. 6 to illustrate that the rotor gaps G3 are below the line 99 and that the lining gaps G4 are above the line 99). In accordance with this invention as shown in FIG. 6A, the inner surface 93D of the rotor 93 is coated according to this invention with a suitable coating material C3 to at least partially fill in and as illustrated, to preferably completely fill in the gaps G3. And also the outer surface 83A of the friction lining 83 is coated according to this invention with a suitable coating material C4 to at least partially fill in and as illustrated, to preferably completely fill in the gaps G4 so that the true contact area between these surfaces is increased.

One example of a suitable coating material which can be used to coat the outer surfaces 83A and 83A′ of the friction linings 83 and 83′, respectively, and/or the inner cylindrical braking surface 93D of the rotor 93 includes two components, namely, a liquid binder and an abrasive particle material. The liquid binder is preferably an inorganic binder comprised of water and sodium silicate (Na₂SO₄). The abrasive particle material is iron oxide (Fe₂O₃). The iron oxide is preferably in the range from about 70 percent pure iron oxide (raw mined) to 100 percent pure iron oxide (synthetically made). In an example of an 85 percent pure iron oxide version, the 15 percent remainder is comprised of around 9 percent silica (SiO₂), around 3 percent aluminum oxide (Al₂O₃), around 1 percent magnesium oxide (MgO), around 0.5 percent calcium oxide (CaO), around 0.5 percent manganese (Mn), and around 1 percent moisture. The concentration ratio by weight of iron oxide to silicate in the particular coating is in the range from about 12 to 1 to about 2 to 1. Preferably, the concentration ratio by weight of iron oxide to silicate in the particular coating is in the range from about 8 to 1 to about 4 to 1. More preferably, the concentration ratio by weight of iron oxide to silicate in the particular coating is approximately 6 to 1. Also, it is believed to be preferable to increase the amount of the silicate which is used in the liquid binder because it results in a harder coating. Also, it is believed that the amount of water which is used in the liquid binder can be varied according to particular processing needs, such as for example, temperature and humidity, since the water is used primarily as a processing agent will mostly disappear in the finished product. The coating is applied to form a relatively thin layer of generally uniform thickness on the outer surfaces 83A and 83A′ of the friction linings 83 and 83′, respectively, and/or the inner cylindrical braking surface 93D of the rotor 93. The thin layer of coating has a generally uniform thickness in the range from about 0.0001 inches to about 0.01 inches. Preferably, the coating has a generally uniform thickness in the range from about 0.0005 to about 0.0025 inches. More preferably, the coating has a generally uniform thickness in the range from about 0.001 to about 0.002 inches.

In accordance with the provisions of the patent statutes, the principle and mode of operation of this invention have been described and illustrated in its preferred embodiments. However, it must be understood that the invention may be practiced otherwise than as specifically explained and illustrated without departing from the scope or spirit of the attached claims.

1. A method for producing a brake component adapted for use in a vehicle brake assembly comprising the steps of:
(a) providing a brake component selected from the group consisting of brake shoe and a brake rotor, the brake shoe including a friction lining having an outer surface having surface irregularities and the brake rotor including an inner cylindrical braking surface having surface irregularities;
(b) applying a liquid binder material to at least a portion of one of the outer surface of the friction lining of the brake shoe and the inner cylindrical braking surface of the brake rotor; and
(c) applying a coating material to at least a portion of one of the outer surface of the friction lining of the brake shoe and the inner cylindrical braking surface of the brake rotor to at least partially fill in the surface irregularities thereof and thereby increase a contact area between the outer surface of the friction lining and the inner cylindrical braking surface of the brake rotor.

2. The method according to claim 1 wherein step (b) is performed prior to step (c).

3. The method according to claim 1 wherein step (b) and step (c) are performed simultaneously by mixing together the liquid binder and the coating material to form a slurry or paste mixture.

4. The method according to claim 3 wherein the mixture is applied by a process selected from the group consisting of spraying, dipping, blotting, brushing, ink-padding and rolling.

5. The method according to claim 1 wherein the liquid binder is selected from the group consisting of a liquid phenolic resin and a silicate binder.

6. The method according to claim 5 wherein water is added to the liquid binder.

7. The method according to claim 1 wherein the coating material is selected from the group consisting of iron oxide powder (Fe₂O₃); aluminum oxide powder (Al₂O₃); zircon powder; and calcium oxide powder (CₐCO₃).

8. The method according to claim 1 wherein the liquid binder is a silicate binder and the coating material is iron oxide powder.

9. The method according to claim 8 wherein a concentration ratio by weight of iron oxide to silicate is in the range from about 8 to 1 to about 4 to 1.

10. The method according to claim 1 wherein the layer of coating material has a generally uniform thickness in the range from about 0.0001 to about 0.01 inches.

11. The method according to claim 1 wherein in step (b) the liquid binder material is applied to only at least a portion of the outer surface of the friction lining of the brake shoe and in step (c) the coating material is applied to only at least a portion of the outer surface of the friction lining of the brake shoe.

12. The method according to claim 1 wherein in step (b) the liquid binder material is applied to only at least a portion of inner cylindrical braking surface of the brake rotor and in step (c) the coating material is applied to only at least a portion of the inner cylindrical braking surface of the brake rotor.

13. The method according to claim 1 wherein in step (b) the liquid binder material is applied to at least a portion of both of the outer surface of the friction lining and inner cylindrical braking surface of the brake rotor and in step (c) the coating material is applied to at least a portion of both of the outer surface of the friction lining and the inner cylindrical braking surface of the brake rotor.

14. A brake shoe produced according to the method of claim 1.

15. A brake rotor produced according to the method of claim 1.

16. A brake component adapted for use in a vehicle brake assembly comprising:
a brake component selected from the group consisting of a brake shoe and a brake rotor, the brake shoe including a friction lining having an outer surface having surface irregularities and the brake rotor including an inner cylindrical braking surface having surface irregularities, said surfaces of said brake components disposed adjacent one another and adapted to frictionally engage one another when the brake assembly is actuated, wherein said brake component surface having said surface irregularities prevents complete contact between said adjacent surfaces of said brake components prior to any burnishing or other contact or wear of components, whereby a green static coefficient of friction between said adjacent surfaces of said brake components is increased by applying a coating material to at least a portion of said surface of one of said brake components whereby said coating material is operative to at least partially fills in at least some of said surface irregularities so as to increase a contact area between said surfaces of said brake components thereby increasing the green static coefficient of friction between said surfaces of said brake components when the brake assembly is actuated.

17. The brake component according to claim 16 wherein said coating material includes a liquid binder material and a coating material.

18. The brake component according to claim 17 wherein said liquid binder material is selected from the group consisting of a liquid phenolic resin and a silicate binder and said coating material is selected from the group consisting of iron oxide powder (Fe₂O₃); aluminum oxide powder (Al₂O₃); zircon powder; and calcium oxide powder (CₐCO₃).

19. The brake component according to claim 18 wherein said liquid binder material is a silicate binder and said coating material is iron oxide powder.

20. The brake component according to claim 19 wherein a concentration ratio by weight of iron oxide to silicate is in the range from about 8 to 1 to about 4 to 1.

21. The brake component according to claim 16 wherein said coating material has a generally uniform thickness in the range from about 0.0001 to about 0.01 inches.

22. A drum-in-hat disc brake assembly including the brake component according to claim 16.
